(19) United States
(12) Patent Application Publication
(10) Pub. No.: US 2020/0212433 A1
(43) Pub. Date: Jul. 2, 2020

(54) Utilization of Reduced Graphene Oxide for High Capacity Lithium Ion Battery

(71) Applicant: SF Motors, Inc., Santa Clara, CA (US)

(72) Inventors: Willy Sandi Halim, Santa Clara, CA (US); Yu-Hsin Huang, Milpitas, CA (US); Chien-Po Huang, Campbell, CA (US); Ying Liu, Santa Clara, CA (US); Yifan Tang, Santa Clara, CA (US); Chengyu Mao, Santa Clara, CA (US)

(73) Assignees: Chongqing Jinkang New Energy Vehicle, Ltd., Chongqing (CN); SF Motors, Inc., Santa Clara, CA (US)

(21) Appl. No.: 16/237,540

(22) Filed: Dec. 31, 2018

(51) Int. Cl. H01M 4/1393; H01M 4/62; H01M 10/0525

(52) U.S. Cl. CPC H01M 4/1393; H01M 2004/027; H01M 10/0525; H01M 4/622

(57) ABSTRACT

Systems and methods for manufacturing an electrode is provided. An example method may comprise disposing, by a blade, a slurry onto a surface of a current collector, the slurry including an active material and a solvent, applying, by an electric field source, an electric field between the blade and the current collector, and drying the slurry applied to the surface of the current collector to remove the solvent. The electric field is applied continuously while the slurry is disposed onto the surface of the current blade. The electric field affects the structure of portions of the slurry by causing a Van der Waals interaction and a polarization attraction between the active material and the current collector. The slurry may include of 95% graphite, 3% of a binder, and 5% of reduced graphene oxide. The solvent may include 4 to 1 mixture of water and isopropyl alcohol.

### BACKGROUND

Lithium ion batteries have become very popular for products and systems suited for rechargeable battery solutions. To manufacture a lithium battery, electrodes are constructed using a slurry coating applied to a current collector material. Currently, graphite anode and binder, typically, carboxymethyl cellulose (CMC) and styrene butadiene rubber (SBR), are used to deposit active materials onto a current collector. A graphite anode can have a capacity of about 372 milliampere hour per gram (mAhg⁻¹). Therefore, usage of the graphite anode may degrade capacity of the lithium battery. Binders do not participate in the lithiation or delithiation processes. In addition, the binders increase charge transfer resistance in cells. Typically, the amount of the binder in the cells is about 5%. Therefore, when all the cells are assembled into a pack module, even 1% can be a significant factor for the total overall capacity. What is needed is a to increase the power in a lithium battery from a manufacturing and/or processing standpoint.

### SUMMARY

The present innovative technology, roughly described, uses an active material to reduce content of inactive binder material in a slurry mixture and applies an electrical field to a blade to dispose the slurry mixture onto a current electrode in order to achieve a stronger contact between the slurry mixture and the surface of the current electrode. The active material may include a reduced graphene oxide. Admixture of the reduced graphene oxide to the slurry mixture may increase the performance of the current electrode because the reduced graphene oxide has energy density above 1000 mAhg⁻¹, which is higher than the energy density of graphite currently used in the slurry mixture. Therefore, usage of the reduced graphene oxide in the slurry coating of a current electrode of a battery may increase total capacity of the battery.

According to one embodiment of the disclosure, a system for manufacturing an electrode is disclosed. The system can include a coating machine configured to secure a current collector. The system may include a blade configured to dispose a slurry onto a surface of the current collector. The slurry may include an active material and an inactive material. The system may further include an electric field source configured to apply an electric field between the blade and the current collector.

The electric field can be applied continuously while the slurry is being disposed onto the surface of the current collector. Applying the electric field affects the structure of at least a portion of the slurry by causing an interaction between the graphene oxide active material and the current collector. Applying the electric field may cause polarization attraction and Van der Waals interaction between oxide groups from the graphene oxide and positively charged current collector to secure contact between the slurry and the surface of the current collector.

The blade is configured to dispose the slurry at a thickness of 65 micrometers. The electric field source can be configured to apply an electric field of at least 50 volts. The electric field source can be configured to provide a negative charge to the blade and a positive charge to the current collector.

The active material may include a reduced graphene oxide. The slurry may include a 40% solution of a solid content dissolved in a 4 to 1 mixture of water and isopropyl alcohol. The solid content may comprise 92% of graphite, 3% of a binder, and 5% of reduced graphene oxide.

According to another embodiment of the disclosure, a method for manufacturing of an electrode is disclosed. The method may include disposing, by a blade, slurry onto a surface of a current collector. The slurry may include an active material and solvent. The method may include applying, by an electric field source, an electric field between the blade and the current collector. The electric field may affect the structure of portions of the slurry by causing an interaction between the active material and the current collector. The method may include drying the slurry applied to the surface of the current collector to remove the solvent.

The active material includes a reduced graphene oxide. The slurry may include a 40% solution of a solid content in a 4 to 1 mixture of water and isopropyl alcohol. The solid content may comprise 92% of graphite, 3% of a binder, and 5% of reduced graphene oxide. The method may include mixing the slurry for 30 minutes by a planetary ball mixer.

According to yet another embodiment of the disclosure, an electrode of a rechargeable battery is disclosed. The electrode may include a current collector and slurry coating disposed onto a surface of the current collector. The slurry coating may include an active material. The slurry may have a structure that aligns in response to an electric field applied to the slurry and the current collector while the slurry is disposed onto the surface of the current collector. The electric field can be applied to cause a Van der Waals interaction or a polarization attraction between oxide content from graphene oxide and positively charged current collector, which causes a better adherence between active materials and surface current collectors

The active material may include a reduced graphene oxide. Prior to being disposed, the slurry may include 40% solution of a solid content. The solid content may comprise 92% of graphite, 3% of a binder, and 5% of reduced graphene oxide. The solid content may be dissolved in a 4 to 1 mixture of water and isopropyl alcohol.

### BRIEF DESCRIPTION OF FIGURES

FIG. 1A is a block diagram of a system for manufacturing an electrode.

FIG. 1B is a block diagram of a system for manufacturing an electrode.

FIG. 2 is a flow chart showing steps of a method for generating a lithium battery.

FIG. 3 is a flow chart showing steps of a method for constructing electrodes.

FIG. 4 illustrates a table showing slurry coating components.

FIG. 5 is a flow chart showing steps of a method for generating slurry for coating an electrode.

FIG. 6 illustrates slurry with active material particles applied to a current collector and an orientation of applied electric field.

FIG. 7A illustrates slurry with active material particles and inactive material particles applied to a current collector.

FIG. 7B illustrates slurry with active material particles applied to a current collector.

### DETAILED DESCRIPTION

The present technology is concerned with manufacturing electrodes for batteries. Specifically, embodiments of the discourse include replacing or minimizing an inactive binder material in a slurry used for coating a current collector of an electrode in an electrochemical cell. The inactive binder material can be replaced with an active material to reduce content of inactive binder material in a slurry mixture.

For example, a reduced graphene oxide can be embedded into the slurry to minimize amount of the inactive binder. The slurry with the active materials can be deposited onto a surface of the current collector using a blade. During the deposition of the slurry onto the surface of the current collector, an electrical field can be applied to the blade and the current collector. The electrical field can improve the contact between the slurry and the surface of the current collector because the electric field induces Van Der Walls interactions and polarization attraction between the active material and the surface (e.g., a copper surface) of the current collector. As a result, the electron pathway of the electrode is improved, interfacial and charge transfer resistance of the electrode is decreased, and diffusion of lithium ion in the electrode is increased.

Current methods for manufacturing electrodes for electrochemical cells use a slurry coating having a graphite as an active material and CMC or SBR as a binder. Conventional processes of coating utilize the binder for the adhesion between the active material and the surface of the current collector of an electrode. Use of the binder in a slurry coating can result in an increased charge transfer resistance in cells, thereby reducing the total capacity of the cells. By decreasing the content of the inactive binder and by increasing the active material, the total capacity of the electrochemical cells can be increased. For example, the binder can be partially replaced with a reduced graphene oxide. The graphite has a lower capacity than the reduced graphene oxide. Therefore, partially replacing the graphite with the reduced graphene oxide may also increase the capacity of the electrochemical cells.

Use of graphene oxide as an anode active material may result in a higher capacity for lithium ion battery. However, graphene oxide has an insulating property because of myriad oxide contents on the carbon edge. This may hinder the electron pathway and deteriorate the performance of electrochemical cells of a battery. To mitigate these effects, in some embodiments of the disclosure, graphene oxide is heat-treated under an argon flow at 350 degrees Celsius for two hours to generate a reduced graphene oxide. During the reduction process, lattice defects can be formed in the reduced graphene oxide structure. At a higher content, graphene oxide tends to agglomerate and undermine the lithium intercalation. Due to the presence of the lattice defects and effects of agglomeration in the reduced graphene oxide, a complete replacement of the graphite with the reduced graphene oxide may not be viable in the battery. In some embodiments of the present disclosure, a relatively small amount of reduced graphene oxide (5% of total content of slurry coating) is added to the electrode. As a result, reduced graphene oxide structure can be stabilized in the battery.

The disclosed technology provides a technical solution to the technical problem of manufacturing lithium-ion batteries. Specifically, the present technology provides an improved method for manufacturing a lithium-ion battery that involves replacing or minimizing a lower capacity material and inactive binder materials with a higher capacity active material in a slurry used for coating current collectors of electrodes. The improved method may also include applying an electric field to the slurry and a surface of a current collector during the deposition of the slurry onto the surface of the current collector. The electrical field may induce a polarization attraction and cause Van der Waals interactions between active materials and the surface. Minimizing content of the binder in the slurry may improve electrical and ionic conductivity in the electrode and, thereby, increase the total capacity of lithium-ion batteries. By minimizing the binder and implementing reduced graphene oxide in the slurry, the ionic and electrical conductivity of electrodes can be improved. Due to the interaction between the reduced graphene oxide and current collector, the reduced graphene oxide can serve as a binder and active material simultaneously, minimizing the necessities of the inactive binder materials in the slurry coating of current collectors of lithium-ion batteries.

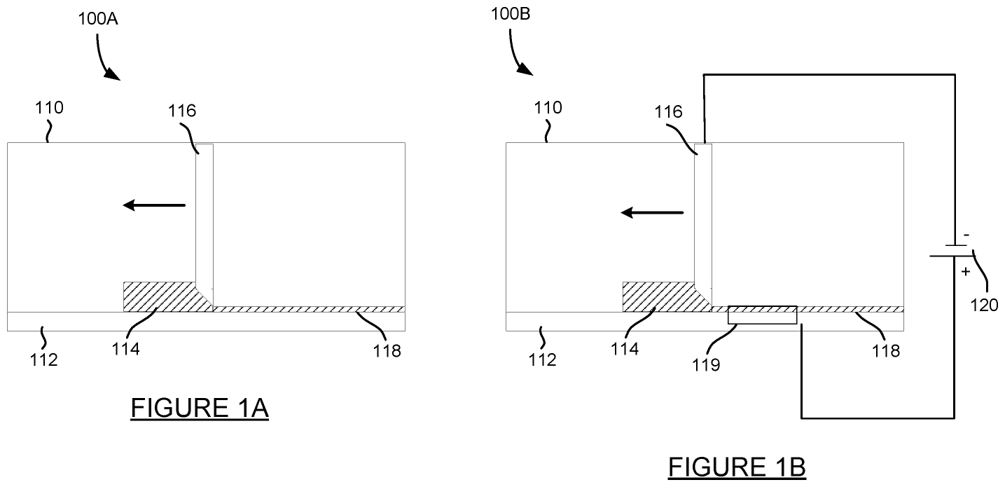

FIG. 1A is a block diagram of a system 100A for manufacturing an electrode according to some currently used technology. The system 100A may include a coating machine 110. The system of FIG. 1 is exemplary and, for purposes of this discussion, only illustrates selected portions of a typical electrode manufacturing system. The coating machine 110 may include a current collector 112, a reservoir of slurry 114, a blade 116, and slurry 118 applied to the current collector. The coating machine 110 may receive and/or supports the current collector 112. The coating machine 110 may secure the current collector 112 such that slurry can be applied to its surface. The current collector 112 may include a sheet or foil of material, such as copper or aluminum.

A reservoir of slurry 114 may be used to apply the slurry in a thin film to current collector 112 using a slurry applicator device, such as, for example, blade 116. The blade 116 may be moved along the current collector 112 at a particular height to create a film of a predefined thickness. The current collector 112 may be comprised of different materials, depending on the type of electrode and the application. In some embodiments, an anode current collector can be made of copper while a cathode current collector can be made of aluminum.

FIG. 1B is a block diagram of a system 100B for manufacturing an electrode, according to some embodiments of the present disclosure. Similar to the system 100A of FIG. 1A, the system 100B may include a coating machine 110. The coating machine 110 may include a current collector 112, a reservoir of slurry 114, a blade 116, and slurry 118 applied to the current collector. The coating machine 110 may receive and/or supports the current collector 112. The coating machine 110 may secure the current collector 112 such that its surface can receive an application of slurry. The current collector 112 may include a sheet or foil of material, such as copper or aluminum.

A reservoir of slurry 114 can be applied as a thin film to current collector 112 using a slurry applicator device, such as, for example, blade 116. The blade 116 may be moved along the current collector 112 at a particular height to create a film of a predefined thickness. The current collector 112 may be comprised of different materials, depending on the type of the electrode and the application. In some embodiments, an anode current collector can be made of copper while a cathode current collector can be made of aluminum.

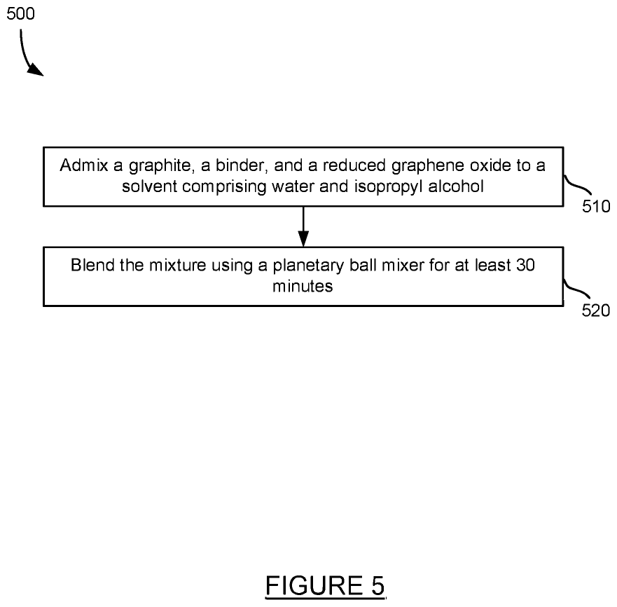

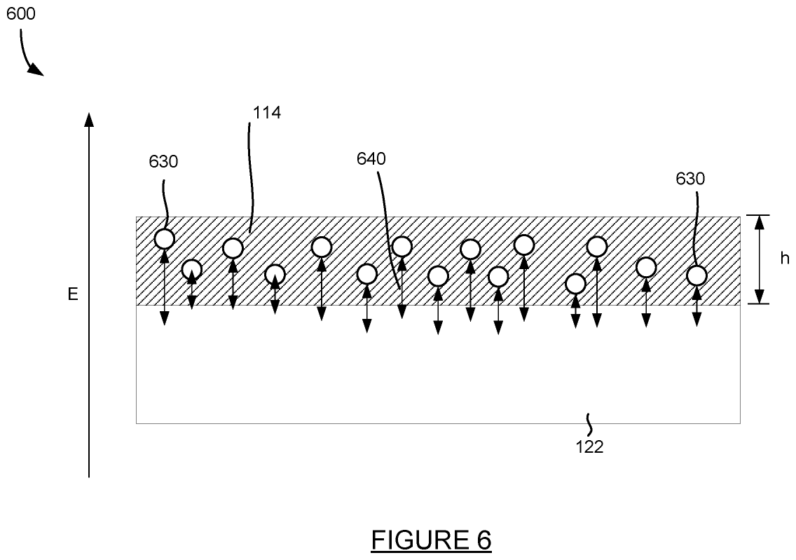

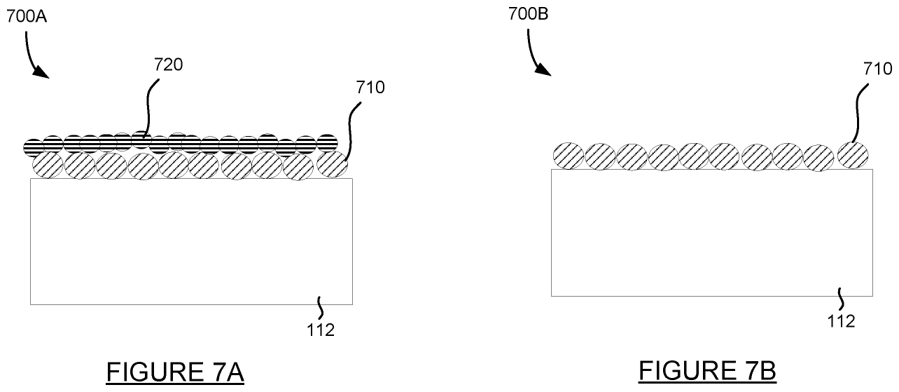

The slurry 114 deposited onto a surface of the current collector may include active materials. In some embodiments, the active materials may include a reduced graphene oxide. Composition of a slurry is discussed in more detail below with reference to FIG. 5. Additional details concerning the slurry and current collector cross-section portion 119 are provided below with reference to FIG. 6, FIG. 7A, and FIG. 7B.

Similar to system 100A, system 100B may include an electrical field source 120 to apply an electric field to the slurry inside the coating machine 110 while applying the slurry to the current collector 112. The electric field can be applied to the slurry to induce a polarization attraction and Van der Waals interactions between particles of the active material and a surface of the current collector and, thereby, securing the contact between the slurry and the surface of the current collector.

The electrical field source 126 can be positioned, manipulated, and secured inside or outside the coating machine 110. The electrical field source 126 can be controlled by an electrical field source controller. The electrical field source may include a generator or a battery configured to generate a direct current. The electrical field source 126 may be in contact with the blade 116 and the current collector 112. In some embodiments, the electrical field source can provide a negative charge to the current controller 112 and positive charge to the blade 116. An electrical field between the blade 116 and the current collector 112 may induce interaction between some particles of the slurry and the surface of the current collector as illustrated by FIG. 6 and discussed in more detail below. The electrical field source controller may manipulate parameters for electrical current produced by the electrical field source 126, such as the amperage and voltage.

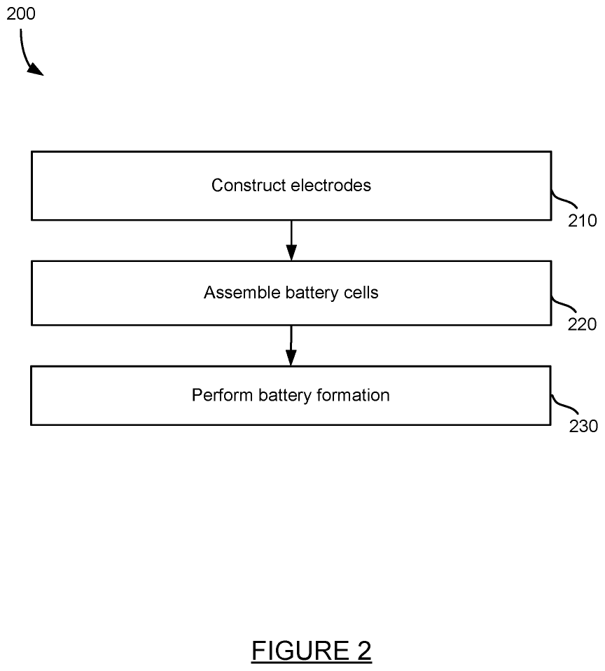

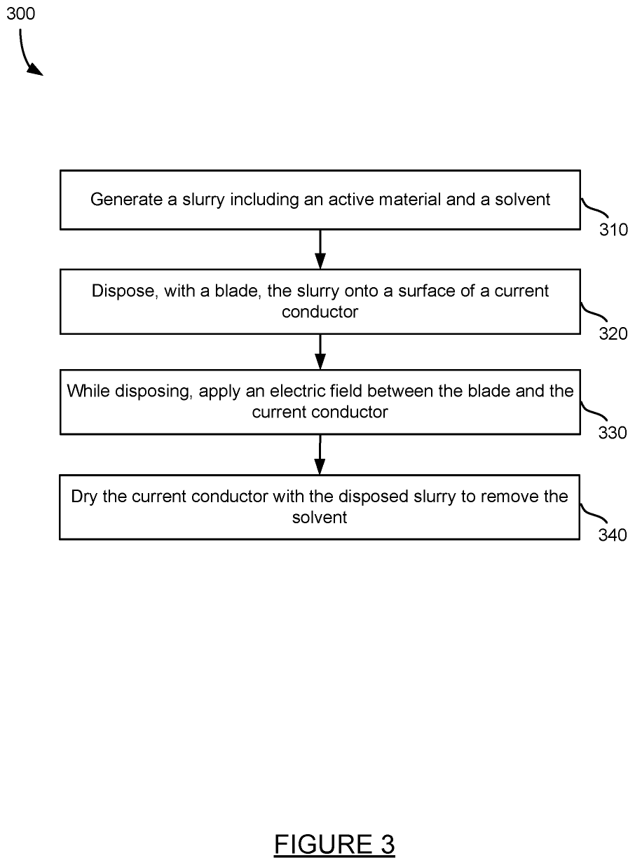

FIG. 2 is a flow chart illustrating steps of a method for generating a lithium battery. The method for generating a lithium battery may be used for different types of rechargeable lithium batteries, such as those used in electric vehicles, phones, and other devices. Initially, electrodes can be constructed at step 210. To generate an electrode, a slurry may be generated and disposed onto a current collector. While being disposed on the surface of the current collector, the slurry may be subjected to an electrical field. Thereafter, the selected material may be split into appropriately sized electrodes. More details for generating electrode are provided below with reference to the method illustrated by FIG. 3.

Battery cells may be assembled at step 220. Assembly of lithium-ion battery cells may include connecting electrodes, inserting electrode structures into a case, and building an electrode subassembly. The subassembly may then be injected into a can and the can be sealed while leaving an opening for injecting electrolytes into the can. The cells can then be filled with electrolytes and sealed. A battery formation is then performed at step 230. The battery formation may involve subjecting the cell to a precisely controlled charge and discharge cycle to activate the active materials of the battery and to transform them into a usable form.

FIG. 3 is a flow chart illustrating steps of a method 300 for constructing electrodes. The method of FIG. 3 provides additional details for step 210 of the method of FIG. 2. At step 310, the method 300 may generate a slurry. The slurry can be generated as a mixture of an active material and the binder, wherein an amount of the binder is reduced with the active material. The slurry may include a solvent. These materials are mixed in a planetary vacuum mixer, sometimes with water and/or other materials, for a period of time required to achieve a complete and even mixture. In some instances, the ingredients are placed in a planetary vacuum mixer for 30 to 40 minutes.

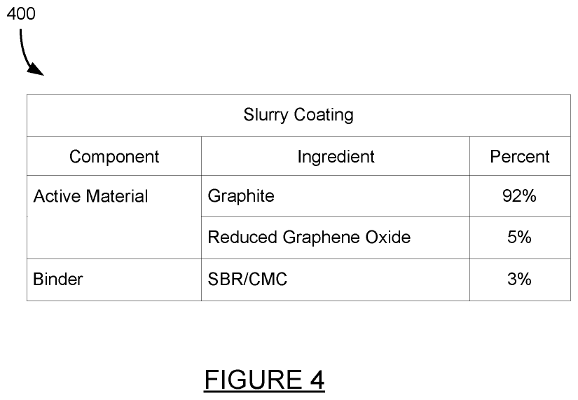

FIG. 4 is a table 400 showing a percentage makeup of some suitable slurry coating components. The slurry may include an active material and binder. The active material may form 97% of a solid content of the slurry. The binder may form 3% of the solid content of the slurry. The active material may include graphite and reduced graphene oxide. The graphite may form 92% of the solid content of the slurry. The reduced graphene oxide may form 5% of the solid content of the slurry. In other embodiments, the active material may also include silicon oxide, or some other suitable active material for an anode. The binder may include SBR, CMC, or some other suitable binders. In some embodiments, the percentage makeup of the active material and other materials in the solid content of the slurry may differ from percentages illustrated in FIG. 4, depending on the application of the battery and the structure desired in the dried slurry.

FIG. 5 is a flow chart illustrating steps of a method 500 for generating a slurry. The method 500 of FIG. 5 provides more details for step 310 of the method 300 of FIG. 3. At step 510, the method 500 may be used to admix a graphite, a binder, and reduced graphene oxide to a solvent comprising water and isopropyl alcohol. At step 520, the method 500 may include blending the mixture of a graphite, a binder, reduced graphene oxide, water and isopropyl alcohol using a planetary ball mixer for at least 30 minutes. An amount of the solid content in the generated structure can be 40%. The solid content may include a graphite, binder, and reduced graphene oxide in proportions illustrated in table 400 of FIG. 4. The ratio of water to isopropyl alcohol can be 4 to 1.

Referring back to FIG. 3, method 300 may include, disposing the slurry onto a surface of a current collector at step 320. The slurry may be applied in a manner that leaves a thin-film on the current collector surface. For example, a doctor blade (also referred to as a blade) or other suitable application mechanism may apply the slurry at a thickness that is suitable for the particular application. In some embodiments, the blade may be used to apply the slurry to a current collector at a thickness of 65 μm.

At step 330, the method 300 may apply an electric field between the blade and the current collector while disposing the slurry onto the surface of the current collector. The disposition process using an electric field is discussed in more detail below with reference to FIG. 6, FIG. 7A, and FIG. 7B.

At step 340, the method 300 may include drying the current collector with the disposed slurry to remove the solvent. The slurry on the current collector can be dried at a room temperature.

FIG. 6 illustrates a slurry 114 with active material particles 730 applied to a current collector 122. The slurry 114 and current collector shown in FIG. 6 provide additional details for the slurry and conductor cross-section portion 119 illustrated in FIG. 1. The slurry 118 is a mixture of an active material and a binder. The height h of the slurry on the current collector may be about 65 micrometers (μm), corresponding to the height of a doctor blade used to create the thin film.

The particles 610 may include nanoparticles of reduced graphene oxide dispersed throughout the slurry. In some embodiments, an electric field is applied between the blade and the current collector. The strength E of the electric field can depend on a type of material and a size of the blade, a type of material and a size of the current collector, and the height h. For example, the blade can be made of stainless steel, the current collector can be made of copper material, the height h can be about 65 μm, and the strength E of the electrical field cab be at least 50 volts.

The electric field can induce a polarization attraction and Van der Waals interactions 640 between the reduced graphene oxide particles 630 and the current collector. The polarization attraction and Van der Waals interactions 640 may secure contacts between the slurry 114 and the surface of the current collector.

FIG. 7A illustrates a conventional composition 700A of slurry disposed onto a surface of a current collector 112 of a lithium ion battery. The conventional composition 700A is typically used for slurry coating an anode. The conventional composition 700A may include particles 710 of an active material, such as graphite and silicon oxide (SiO), and particles 720 of binder materials, such as SBR and CMC.

FIG. 7B illustrates a composition 700B of the slurry disposed onto a surface of a current collector 112 of a lithium ion battery, according to embodiments of the present disclosure. The composition 700B can be used for slurry coating an anode. The conventional composition 700B may include substantially particles 710 of active materials, such as graphite, silicon oxide (SiO), and reduced graphene oxide. The presence of the particles of binder materials in the composition 700B can be either excluded or minimized.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A system for manufacturing an electrode, the system comprising:
a coating machine configured to secure a current collector;
a blade configured to dispose a slurry onto a surface of the current collector, the slurry including an active material; and
an electric field source configured to apply an electric field between the blade and the current collector, the electric field affecting the structure of at least a portion of the slurry by causing an interaction between the active material and the current collector,
wherein the electric field source is configured to provide a negative charge to the blade and a positive charge to the current collector.

2. The system of claim 1, wherein the active material includes a reduced graphene oxide.

3. The system of claim 1, wherein the electric field is applied to cause a Van der Waals interaction between particles of the active material and the surface of the current collector.

4. The system of claim 1, wherein an electric field is applied to induce a polarization attraction between particles of the active material and the current collector.

5. The system of claim 1, wherein the slurry includes a 40% solution of a solid content, the solid content comprising 92% of graphite, 3% of a binder, and 5% of reduced graphene oxide, the solid content being dissolved in a 4 to 1 mixture of water and isopropyl alcohol.

6. The system of claim 1, wherein the electric field is applied continuously while the slurry is being disposed onto the surface of the current collector.

7. The system of claim 6, wherein:
the blade is configured to dispose the slurry at a thickness of 65 micrometers; and
the electric field source is configured to apply an electric field of at least 50 volts.

8. (canceled)

9. A method for manufacturing an electrode, the method comprising:
disposing, by a blade, a slurry onto a surface of a current collector, the slurry including an active material and a solvent;
applying, by an electric field source, an electric field between the blade and the current collector, the electric field affecting the structure of portions of the slurry by causing an interaction between the active material and the current collector; and
drying the slurry applied to the surface of the current collector to remove the solvent.

10. The method of claim 9, wherein the active material includes a reduced graphene oxide.

11. The method of claim 9, wherein the electric field is applied to cause a Van der Waals interaction between particles of the active material and the surface of the current collector.

12. The method of claim 9, wherein an electric field is applied to induce a polarization attraction between particles of the active material and the current collector.

13. The method of claim 9, wherein the slurry includes a 40% solution of a solid content, the solid content comprising 92% of graphite, 3% of a binder, and 5% of reduced graphene oxide, the solid content being dissolved in a 4 to 1 mixture of water and isopropyl alcohol.

14. The method of claim 9, further comprising mixing the slurry for 30 minutes by a planetary ball mixer.

15. The method of claim 9, wherein the electric field is applied continuously while the slurry is being disposed onto the surface of the current blade.

16. The method of claim 15, wherein:
the blade is configured to dispose the slurry at a thickness of 65 micrometers; and
the electric field source is configured to apply an electric field of at least 50 volts and provide a negative charge to the blade and a positive charge to the current collector.

17. An electrode of a rechargeable battery, the electrode comprising:
a current collector; and
a slurry coating disposed onto a surface of the current collector, the slurry coating including an active material, the slurry having a structure configured to align in response to an electric field applied to the slurry and the current collector while the slurry is disposed onto the surface of the current collector,
wherein the electric field is applied to cause one of a Van der Waals interaction and a polarization attraction between particles of the active material and the surface of the current collector.

18. The electrode of claim 17, wherein the active material includes a reduced graphene oxide.

19. (canceled)

20. (canceled)
